(19) United States
(12) Patent Application Publication
(10) Pub. No.: US 2016/0375660 A1
(43) Pub. Date: Dec. 29, 2016

(54) RESIN FILM, COMPOSITE SHEET USING SAME, AND RESIN MOLDED MEMBER

(71) Applicant: NISSEN CHEMITEC CORPORATION, Niihama-shi, Ehime (JP)

(72) Inventors: Katsushi JINNO, Niihama-shi, Ehime (JP); Takashi FUJITA, Niihama-shi, Ehime (JP); Yutaro KAN, Niihama-shi, Ehime (JP); Nozomu BITO, Niihama-shi, Ehime (JP); Hayato SHINOHARA, Kochi-shi, Kochi (JP); Minoru YAMASHITA, Kochi-shi, Kochi (JP); Nozomu TSURUTA, Kochi-shi, Kochi (JP)

(21) Appl. No.: 15/039,721

(22) PCT Filed: Dec. 1, 2014
(86) PCT No.: PCT/JP2014/005997

§ 371 Date: May 26, 2016

(30) Foreign Application Priority Data
Dec. 19, 2013 (JP) 2013-263064

(51) Int. Cl. B32B 27/12; B32B 5/02; B32B 27/32

(52) U.S. Cl. CPC B32B 27/12; B32B 27/32; B32B 5/022; B32B 2605/003

(57) ABSTRACT

Provided is a resin film that can be firmly adhered to fabric materials formed of chemical/synthetic fibers and natural fibers such as Japanese paper, nonwoven fabrics, textiles, and tatami-matting, and that has extremely low moisture permeability and oxygen permeability for enabling the fabric material to be suitable as excellent automobile interior materials, railroad vehicle interior materials, members for housings, and household appliance members. More specifically, the present invention is a resin film (10) including: a melt-adhesion filling layer (12) formed of an olefin based resin that contains a modified polyolefin resin and has a melt flow rate (MFR: test condition being 170° C. under a load of 2.16 kg) higher than 0.5 g/10 min but lower than 54.0 g/10 min; and a functional layer (14) formed of a thermoplastic resin and laminated on a surface of the melt-adhesion filling layer (12).

### TECHNICAL FIELD

The present invention relates to: a resin film to be laminated on fabric materials formed of chemical/synthetic fibers and natural fibers such as Japanese paper, nonwoven fabrics, textiles, and tatami-matting; a method for manufacturing a composite sheet using the same; and a resin molded member using the same, such as automobile interior members, railroad vehicle interior members, members for housings, and household appliance members.

### BACKGROUND ART

In recent years, there has been a focus on the excellent design property of fabric materials that are traditional handicrafts such as Japanese paper, textiles (silk textiles, woolen textiles, cotton textiles, and the like), or tatami-matting, and resin molded products provided with beautiful design patterns on surfaces thereof by using such materials are in demand for interior parts of automobiles, furniture, or home appliances, etc.

For example, Patent Literature 1 and 2 disclose, as a decorative synthetic resin sheet having a Japanese paper-like appearance, a Japanese paper-like sheet having a transparent or translucent synthetic resin sheet laminated on one or both surfaces.

However, with these technologies described above, since adhesives do not sufficiently permeate through the Japanese paper-like sheet, when the Japanese paper-like sheet is humidified or immersed in water, interlayer peeling or interfacial peeling occurs easily between the synthetic resin sheet and the Japanese paper-like sheet. In addition, since the synthetic resin sheet on the surface cannot withstand harsh environmental tests for weather resistance, abrasion resistance, moisture resistance, and heat resistance required for use applications in interior of automobiles and railroad vehicles or use applications in construction materials; the synthetic resin sheet has not been used in such products.

Thus, as shown in Patent Literature 3, among thermoplastic resins, when a polyolefin resin having extremely low moisture permeability and oxygen permeability is used as a resin film to be bonded through thermocompression on fabric materials formed of chemical/synthetic fibers and natural fibers such as Japanese paper, nonwoven fabrics, textiles, and tatami-matting; the problems related to color-fading and deterioration evaluated by the environmental tests described above can be solved. In addition, the polyolefin resin has resistance against heat at a temperature of not lower than 100° C. required for use applications in automobile interior.

### CITATION LIST

### Patent Literature

[PTL 1] Japanese Patent No. 2558078

[PTL 2] Japanese Laid-Open Patent Publication No. 2003-025514

[PTL 3] Japanese Laid-Open Patent Publication No. 2011-255542

### SUMMARY OF THE INVENTION

### Problems to be Solved by the Invention

However, although the polyolefin resin described above is a chemically stable plastic with low polarity mostly formed of carbon and hydrogen and has extremely low moisture permeability and oxygen permeability compared to other resins; adhesion of the polyolefin resin with other materials or other plastics is extremely difficult and generally considered impossible since the polyolefin resin has inferior surface wettability.

Thus, simply thermocompression bonding the polyolefin resin film with fabric materials formed of chemical/synthetic fibers and natural fibers such as Japanese paper, nonwoven fabrics, textiles, and tatami-matting as described in Patent Literature 3 has a problem of not being able to manufacture a highly durable composite sheet in which the fabric materials and the resin film are firmly adhered.

Thus, a main objective of the present invention is to provide a resin film that can be adhered firmly with fabric materials formed of chemical/synthetic fibers and natural fibers such as Japanese paper, nonwoven fabrics, textiles, and tatami-matting, and that has extremely low moisture permeability and oxygen permeability for enabling the fabric material to be suitable as excellent automobile interior materials, railroad vehicle interior materials, members for housings, and household appliance members.

An additional objective of the present invention is to provide a composite sheet and a resin molded member suitable for automobile interior materials, railroad vehicle interior materials, members for housings, and household appliance members by compositing and laminating such a resin film and fabric materials formed of chemical/synthetic fibers and natural fibers such as Japanese paper, nonwoven fabrics, textiles, and tatami-matting.

### Solution to the Problems

A first aspect of the present invention is a resin film 10 to be attached to at least one surface of a fabric material 18 formed of a natural fiber or a chemical/synthetic fiber, and the resin film 10 includes:

a melt-adhesion filling layer 12 formed of an olefin based resin that contains a modified polyolefin resin and has a melt flow rate (MFR: test condition being 170° C. under a load of 2.16 kg) higher than 0.5 g/10 min but lower than 54.0 g/10 min; and

a functional layer 14 formed of a thermoplastic resin and laminated on a surface of the melt-adhesion filling layer 12.

In this invention, since the melt-adhesion filling layer 12 of the resin film 10 is formed of an olefin based resin that contains a modified polyolefin resin and has a melt flow rate (MFR: test condition being 170° C. under a load of 2.16 kg) higher than 0.5 g/10 min but lower than 54.0 g/10 min; when the resin film 10 and the fabric material 18 are bonded through thermocompression, the melt-adhesion filling layer 12 penetrates the fabric material 18 to deep parts thereof to cause the resin film 10 and the fabric material 18 to be firmly adhered mainly through an anchoring effect.

The melt flow rate of the olefin based resin forming the melt-adhesion filling layer 12 is preferably within a range of higher than 0.5 g/10 min but lower than 54.0 g/10 min as described above. The reason is because when the melt flow rate is not higher than 0.5 g/10 min, impregnating ability and adhesiveness of the melt-adhesion filling layer 12 with respect to a particularly dense fabric material 18 become inferior; whereas when the melt flow rate is not lower than 54.0 g/10 min, film-formability deteriorates and film formation using inflation molding significantly deteriorates in particular.

In the above described invention, as “a fabric material 18 formed of a natural fiber or a chemical/synthetic fiber”, for example, at least one selected from the group consisting of Japanese paper, nonwoven fabrics, textiles, and tatami-matting may be used.

In the invention described above, an intermediate layer 16 formed of an olefin based polymer alloy or polymer blend is preferably additionally interposed between the melt-adhesion filling layer 12 and the functional layer 14. By interposing the intermediate layer 16, even when the functional layer 14 is formed of a resin other than the olefin based resin as described later, the melt-adhesion filling layer 12 and the functional layer 14 can be firmly joined.

In the present invention, the thermoplastic resin forming the functional layer 14 is preferably at least one type selected from the group consisting of polymethyl methacrylate resins (PMMA), polycarbonate resins (PC), polypropylene resins (PP), ABS resins (ABS), polyester based resins such as polyethylene terephthalate resins (PET) and ester elastomers whose hard segment is polybutylene terephthalate, polyethylene resins (PE), polystyrene resins (PS), and polyurethane resins (PU). With this, the respective functions of the resins can be given to the functional layer 14.

In the present invention, a colored material configured to absorb or diffuse electromagnetic waves having a wavelength of 380 to 500 nm is preferably blended in at least one of the melt-adhesion filling layer 12 or the intermediate layer 16.

Generally, a light-proof prescription for common plastics having an ultraviolet ray absorbing agent blended therein absorbs or diffuses ultraviolet rays having a wavelength not larger than 380 nm. However, by “blending a colored material configured to absorb or diffuse electromagnetic waves having a wavelength of 380 to 500 nm” in combination with the hitherto known light-proof prescription, discoloration and deterioration of the fabric material 18 adhered to the resin film 10 can be prevented more effectively, since ultraviolet rays in a more wider wavelength range and visible-light rays near that can be absorbed or diffused.

In addition, since the “colored material configured to absorb or diffuse electromagnetic waves having a wavelength of 380 to 500 nm” is blended in at least one of the melt-adhesion filling layer 12 or the intermediate layer 16, the functional layer 14 which is located on the outermost surface side when the resin film 10 is adhered to the fabric material 18 maintains excellent transparency and glossiness. Thus, by simply adhering the resin film 10 to the surface of the fabric material 18, a light resistance coloring can be provided to the fabric material 18, and the surface of the fabric material 18 can be finished like a mirror surface.

Examples of the “colored material configured to absorb or diffuse electromagnetic waves having a wavelength of 380 to 500 nm” include blackish or brownish dyes and pigments, including those having colors such as reddish brown, maroon, and dark red, inorganic ultraviolet ray absorbing agents, and iron oxide-based ultraviolet ray absorbing agents.

A second aspect of the present invention is a composite sheet 20 having the resin film 10, according to the first aspect, bonded through thermocompression to, at a temperature not lower than the melting point of the melt-adhesion filling layer 12, at least the outer surface side of the fabric material 18 formed of a natural fiber or a chemical/synthetic fiber.

In the present invention (second aspect), preferably, a nonwoven fabric 34 mainly formed of a fiber capable of maintaining shape at a temperature higher than the melting point of a resin film 11 is interposed between the rear surface of the fabric material 18 formed of a natural fiber or a chemical/synthetic fiber and the resin film 11 to be bonded through thermocompression to the side of the rear surface, or is laminated on the outer surface side of the resin film 11 bonded through thermocompression to the rear surface of the fabric material 18 formed of a natural fiber or a chemical/synthetic fiber.

A third aspect of the present invention is a resin molded member 32 that is molded into a predetermined shape by using the composite sheet 20 of the second aspect of the present invention and that has a thermoplastic base resin material 30 injection-molded on, and integrally formed with, the rear surface of the composite sheet 20.

### Advantageous Effects of the Invention

According to the present invention, it becomes possible to provide a resin film that can be adhered firmly with fabric materials formed of chemical/synthetic fibers and natural fibers such as Japanese paper, nonwoven fabrics, textiles, and tatami-matting, and that has extremely low moisture permeability and oxygen permeability for enabling the fabric material to be suitable as excellent automobile interior materials, railroad vehicle interior materials, members for housings, and household appliance members. Furthermore, by using the resin film of the present invention, a resin molded member and a composite sheet suitable for automobile interior materials, railroad vehicle interior materials, members for housings, and household appliance members can be provided.

### BRIEF DESCRIPTION OF THE DRAWINGS

FIG. 1 includes schematic diagrams showing structures of a resin film according to one embodiment of the present invention, wherein FIG. 1A shows a film having a two-layer structure without an intermediate layer and FIG. 1B shows a film having a three-layer structure with an intermediate layer.

FIG. 2 is an illustrative diagram showing one example of composite sheet manufacturing steps using the resin film of the present invention.

FIG. 3 includes SEM pictures (photographs as substitute for drawings) in which a cross section of the composite sheet according to one embodiment of the present invention is enlarged, wherein FIG. 3A shows a composite sheet using, as a fabric material, a laminated body of Japanese paper and a nonwoven fabric, and FIG. 3B shows a composite sheet using a textile as the fabric material.

FIG. 4 shows a composite sheet of a second embodiment of the present invention, wherein (a) is an illustrative diagram showing one example of manufacturing steps of the composite sheet, and (b) is a schematic diagram in which an end surface of the composite sheet obtained from the process is enlarged.

FIG. 5 shows a composite sheet of a third embodiment of the present invention, wherein (a) is an illustrative diagram showing one example of manufacturing steps of the composite sheet, and (b) is a schematic diagram in which an end surface of the composite sheet obtained from the process is enlarged.

FIG. 6 is an illustrative diagram showing one example of resin molded member manufacturing steps using the composite sheet of the present invention.

FIG. 7 includes photographs as substitute for drawings showing a resin molded member sample created for evaluating followability of the composite sheet with respect to a metal mold during injection molding, wherein FIG. 7A shows a resin molded member sample in which a Japanese paper sheet is used as the composite sheet, and FIG. 7B shows a resin molded member sample in which a fabric sheet is used as the composite sheet.

### DESCRIPTION OF EMBODIMENTS

In the following, a resin film, and a composite sheet and a resin molded member using the resin film of the present invention will be described with reference to the drawings.

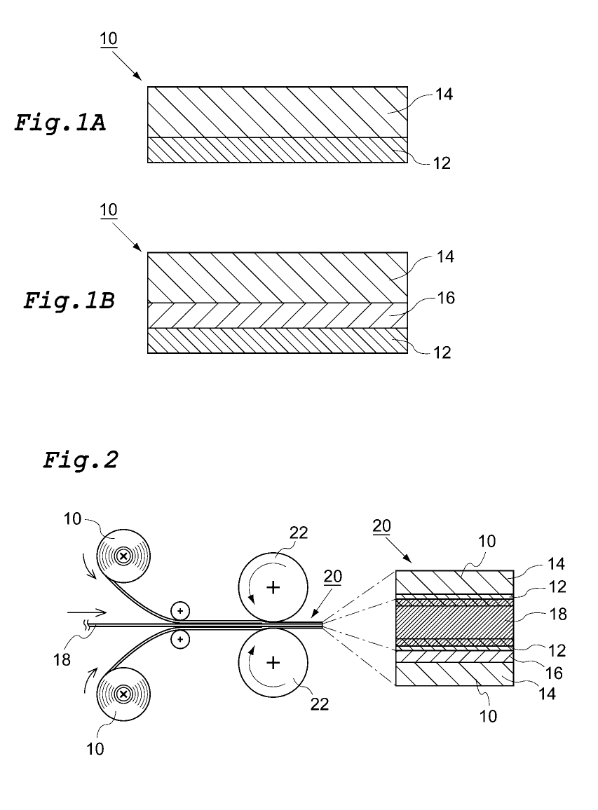

The resin film 10 of the present invention is attached to at least one surface of the fabric material 18 (see FIG. 2) formed of a chemical/synthetic fiber or a natural fiber such as Japanese paper, nonwoven fabrics, textiles, and tatami-matting to protect and decorate the fabric material 18, and includes a type that is formed of the melt-adhesion filling layer 12 and the functional layer 14 as shown in FIG. 1(a) and a type having a structure in which the intermediate layer 16 is interposed between the melt-adhesion filling layer 12 and the functional layer 14 as shown in FIG. 1(b).

The thickness of the resin film 10, although not particularly limited, is preferably within a range of 30 to 500 μm. When the thickness of the resin film 10 is smaller than 30 μm, maintaining sufficient strength required as a material for protecting and decorating the surface of the fabric material 18 becomes difficult; whereas when the thickness of the resin film 10 is larger than 500 μm, the resin film 10 becomes too rigid and flexibility (curved surface followability) required as a material for protecting and decorating the surface of the fabric material 18 is reduced.

The melt-adhesion filling layer 12 is a layer obtained by causing the resin film 10 to thermally melt to permeate into the fabric material 18 when being attached to the surface of the fabric material 18 to fill the structure of the fabric material 18, and is formed of an olefin based resin having a melt flow rate (MFR: test condition being 170° C. under a load of 2.16 kg), measured in conformity to JIS K 7210, higher than 0.5 g/10 min but lower than 54.0 g/10 min., preferably 0.8 to 40.0 g/10 min, and more preferably 1.0 to 10.0 g/10 min. As described above, when the MFR is not higher than 0.5 g/10 min, impregnating ability and adhesiveness of the melt-adhesion filling layer 12 with respect to the fabric material 18 become inferior, whereas when the MFR is not lower than 54.0 g/10 min, film-formability deteriorates and film formation using inflation molding significantly deteriorates in particular.

As described above, since the polyolefin resin is a chemically stable plastic with low polarity and has inferior surface wettability even if the MFR is raised to increase fluidity when being thermal melt, adhesion to the fabric material 18 or other resin is extremely difficult. Thus, in the resin film 10 of the present invention, for the purpose of improving adhesiveness with respect to the fabric material 18 or other resins, a modified polyolefin resin obtained by modifying (e.g., graft modification) the olefin based resin or a copolymer of the olefin based resin and another resin, by using an α, β-unsaturated carboxylic acid or a derivative thereof (e.g., acrylic acid, methyl acrylate) or an alicyclic carboxylic acid or a derivative thereof (e.g., maleic anhydride) is blended in the olefin based resin forming the melt-adhesion filling layer 12.

The modified polyolefin resin introduces a polar group to a non-polar polyolefin resin, and provides adhesiveness against different materials such as the fabric material 18 and other resins. The blending ratio of the modified polyolefin resin with respect to the total amount of the olefin based resin forming the melt-adhesion filling layer 12 is preferably within a range of 2 wt % to 80 wt % and more preferably within a range of 5 wt % to 20 wt %. When the blending ratio of the modified polyolefin resin with respect to the total amount of the olefin based resin forming the melt-adhesion filling layer 12 is lower than 2 wt %, affinity and impregnating ability with respect to the fabric material 18 deteriorate; whereas when the blending ration is higher than 80 wt %, although the impregnating ability becomes extremely good, the amount of resin remaining on the surface of the fabric material 18 becomes less, and adhesive strength with respect to the functional layer 14 (or, the intermediate layer 16) may possibly be reduced.

The functional layer 14 is a layer arranged on the outermost surface side (or rearmost surface side) when forming the composite sheet 20 by attaching the resin film 10 to the fabric material 18. The functional layer 14 is a layer for providing properties and functions specific to the included resin. Thus, when the composite sheet 20 manufactured using the resin film 10 of the present invention is to be used for use applications regarding the interior of automobiles and railroad vehicles, the functional layer 14 is preferably formed of at least one type selected from the group consisting of polymethyl methacrylate resins (PMMA), polycarbonate resins (PC), polypropylene resins (PP), ABS resins (ABS), polyester based resins such as polyethylene terephthalate resins (PET) and ester elastomers whose hard segment is polybutylene terephthalate, polyethylene resins (PE), polystyrene resins (PS), and polyurethane resins (PU). For example, when the functional layer 14 is formed of a polyurethane resin, the surface feel improves, and when the functional layer 14 is formed of an ABS resin, impact resistance improves. Thus, the surface of the resin film 10 (and ultimately the surface of the fabric material 18 formed of a natural fiber or a chemical/synthetic fiber such as Japanese paper, nonwoven fabrics, textiles, and tatami-matting) can be provided with the function specific to each of the resins described above via the functional layer 14.

As described later, when manufacturing the resin molded member 32 by joining the base resin material 30 and the composite sheet 20 manufactured using the resin sheet 10 of the present invention (see FIG. 4); using the same or similar type of resin for the resin forming the functional layer 14 and the base resin material 30 to be joined with the functional layer 14 enables firm joining and integration of the composite sheet 20 and the base resin material 30 with high inter-layer strength.

As shown in FIG. 1(b), the intermediate layer 16 is a layer interposed between the melt-adhesion filling layer 12 and the functional layer 14 if necessary. As described above, the olefin based resin is a chemically stable plastic having low polarity, and even if the modified polyolefin resin is blended in the melt-adhesion filling layer 12, a sufficient inter-layer strength between the melt-adhesion filling layer 12 and the functional layer 14 cannot be obtained in some cases depending on the type of the resin forming the functional layer 14. In such cases, the intermediate layer 16 formed of an olefin based polymer alloy or polymer blend is preferably interposed between the melt-adhesion filling layer 12 and the functional layer 14.

With respect to the olefin based polymer alloy or polymer blend, the same or similar type of resin as the resin forming the functional layer 14 is preferably used as the material resin to be blended together with the olefin based resin. By doing so, the melt-adhesion filling layer 12 and the functional layer 14 can be firmly joined with a high inter-layer strength through the intermediate layer 16.

When manufacturing the resin film 10 formed of the respective layers 12, 14, and 16 as described above, film manufacturing methods known in the art such as inflation method, T-die method, or tubular method, etc., can be used. The respective layers 12, 14, and 16 are preferably laminated and integrated simultaneously when being formed for improving manufacturing efficiency, reducing burden of inventory management, and improving handleability of a product. However, when the respective layers 12, 14, and 16 are to be separately manufactured and attached to the surface of the fabric material 18, the layers 12, 14, and 16 may be laminated and bonded through thermocompression in a predetermined order.

On the respective layers 12, 14, and 16 forming the resin film 10, an additive such as an antiblocking agent, a lubricant, an ultraviolet ray absorbing agent, a weathering stabilizer, a flame retardant, and a colored material configured to absorb or diffuse electromagnetic waves having a wavelength of 380 to 500 nm may be added in addition to the material resin if necessary.

Here, when adding a colored material configured to absorb or diffuse electromagnetic waves having a wavelength of 380 to 500 nm, i.e., ultraviolet rays having a wavelength of 380 to 400 nm and visible-light rays near ultraviolet rays having a wavelength of 400 to 500 nm, more specifically, when adding blackish or brownish dyes and pigments, including those having colors such as reddish brown, maroon, and dark red, inorganic ultraviolet ray absorbing agents, and iron oxide-based ultraviolet ray absorbing agents; the colored material is preferably added to at least one of the melt-adhesion filling layer 12 or the intermediate layer 16. By blending these colored chemical agents to at least one of the melt-adhesion filling layer 12 or the intermediate layer 16, the functional layer 14 can be kept transparent with excellent glossiness. As a result, by simply thermocompression bonding the resin film 10 formed as described above to the surface of the fabric material 18, a light-resistance coloring can be provided to the fabric material 18, and the surface of the fabric material 18 can be finished like a mirror surface.

Next, with reference to FIG. 2, a method for manufacturing the composite sheet 20 using the resin film 10 formed as described above will be described.

The composite sheet 20 is obtained by protecting/decorating the surface of the fabric material 18 by laminating the resin sheet 10 on at least one surface of the fabric material 18.

As described above, the fabric material 18 is a collective term items formed of a natural fiber or a chemical/synthetic fiber, including handmade Japanese paper, machine-made Japanese paper, nonwoven fabrics, textiles (silk textiles, woolen textiles, cotton textiles, hemp textiles, chemical fiber textiles, and mixed textiles thereof, etc.), and tatami-matting, and refers to a sheet-like material having a thickness of about 0.1 to 2.0 mm. Although the Japanese paper and nonwoven fabrics can be made with a wet paper-making method or a dry paper-making method, and many weaving methods such as hand-weaving and machine-weaving exist for the textiles and the tatami-matting; the method for manufacturing the fabric material 18 is not limited to those methods.

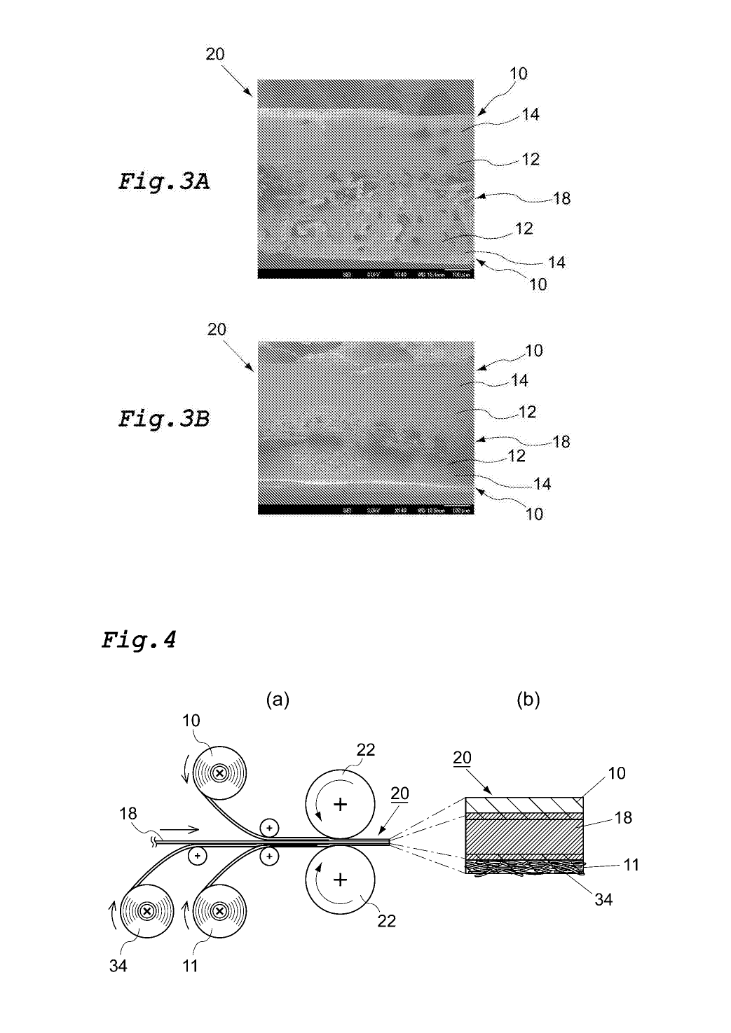

When manufacturing the composite sheet 20 by laminating and integrating the fabric material 18 and the resin film 10 described above, heating rolls 22 as shown in FIG. 2 are used. Specifically, the resin film 10 is laminated at least on one surface of the fabric material 18, and then the laminated sheet is bonded through thermocompression while being pressed with a predetermined pressure when the laminated sheet is sent between the top and bottom pair of the heating rolls 22 heated to a temperature equal to or higher than a melting point of the resin forming the melt-adhesion filling layer 12, and cooled to cause the melt-adhesion filling layer 12 permeate inside the fabric material 18 as shown in FIG. 3 (in FIG. 3, (a) located above is a laminated body of Japanese paper and a nonwoven fabric, and a textile is used for (b) located below) to obtain the composite sheet 20 in which the two are firmly adhered.

It should be noted that although, in FIG. 2, a case is shown in which the resin film 10 having a two-layer structure without the intermediate layer 16 is laminated on the upper side of the fabric material 18, and the resin film 10 having a three-layer structure with the intermediate layer 16 is laminated on the lower side of the fabric material 18; the combination of the fabric material 18 and the resin film 10 is not limited to those described.

In addition, the method for manufacturing the composite sheet 20 is not limited to the method of continuously manufacturing the composite sheet 20 by using the top and bottom pair of the heating rolls 22 as described above, and a method (batch type) of laminating and thermocompression bonding, by using a flat pressing machine, the fabric material 18 and the resin film 10 cut in predetermined lengths may be used.

Furthermore, when manufacturing the composite sheet 20, the following improvement is preferably added if necessary. That is, as shown in (a) of FIG. 4, when laminating the resin film 10 on the surface of the fabric material 18 and laminating the resin film 11 for the rear surface side (needless to say that the resin film 11 may be the resin film 10 of the present invention) on the rear surface of the fabric material 18 through thermocompression bonding by using the heating rolls 22; the nonwoven fabric 34 mainly formed of a fiber capable of maintaining shape at a temperature higher than the melting point of the resin film 11 is interposed between the rear surface of the fabric material 18 and the resin film 11 to be bonded through thermocompression on the rear surface side. By doing so, as shown in (b) of FIG. 4, the nonwoven fabric 34 is arranged from the whole inside over to the outer surface of the resin film 11 for the rear surface side, and the resin film 11 is structured like FRP (Fiber Reinforced Plastics). As a result, as described later, when manufacturing the resin molded member 32 by using injection molding, an adhesion layer formed on the outer surface side of the resin film 11 (with respect to the base resin material 30) is prevented from melting and outflowing due to the flow, pressure, or heat of the base resin material 30 in a heated/molten state to enable prevention of poor adhesion between the two. In addition, since an anchoring effect is exerted between the base resin material 30 and the nonwoven fabric 34 dispersed on the outer surface of the resin film 11, the two can be firmly joined. In addition, as described above, since the resin film 11 is structured like FRP, the composite sheet 20 can be rigidly formed.

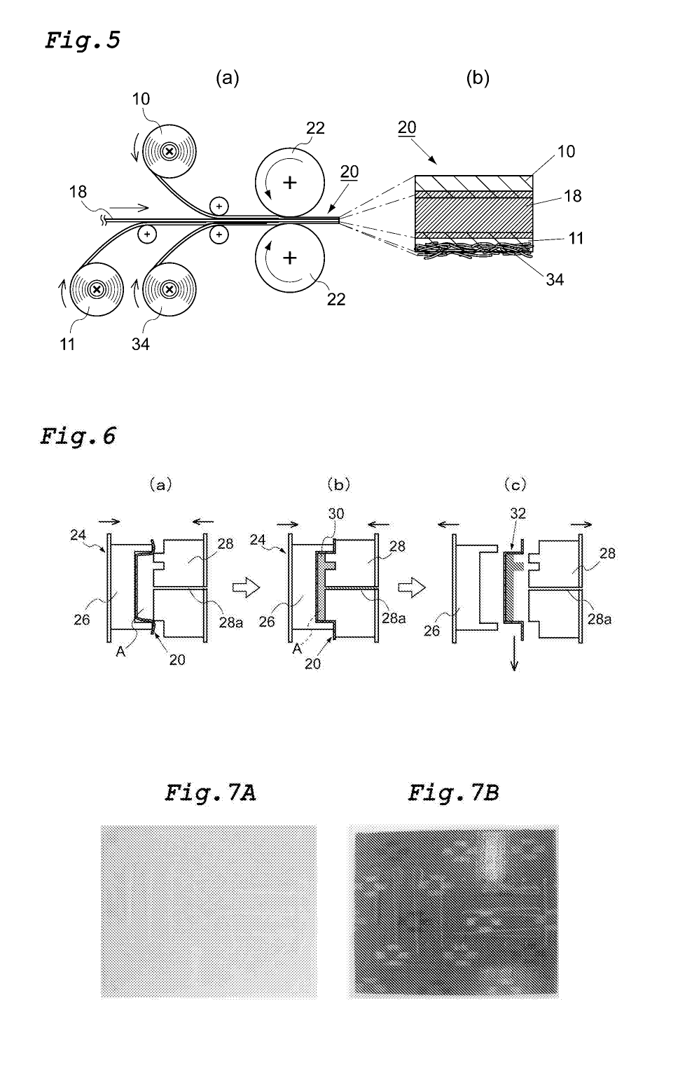

Still further, as shown in (a) of FIG. 5, when laminating the resin film 10 on the surface of the fabric material 18 and laminating the resin film 11 for the rear surface side (needless to say that the resin film 11 may be the resin film 10 of present invention) on the rear surface of the fabric material 18 through thermocompression bonding by using the heating rolls 22; the nonwoven fabric 34 mainly formed of a fiber capable of maintaining shape at a temperature higher than the melting point of the resin film 11 is laminated on the outer surface side of the resin film 11. By doing so, as shown in (b) of FIG. 5, the nonwoven fabric 34 is arranged from within the outer surface side of the resin film 11 over to the outer surface thereof As a result, similarly to above, when manufacturing the resin molded member 32 by using injection molding, an adhesion layer formed on the outer surface side of the resin film 11 (with respect to the base resin material 30) is prevented from melting and outflowing due to the flow, pressure, or heat of the base resin material 30 in a heated/molten state to enable prevention of poor adhesion between the two. In addition, since more of the nonwoven fabric 34 is arranged on the outer surface of the resin film 11, a larger anchoring effect is exerted between the nonwoven fabric 34 and the base resin material 30, and the two can be joined more firmly. It should be noted that when the nonwoven fabric 34 is laminated on the outer surface side of the resin film 11, although increase in the rigidity of the composite sheet 20 cannot be expected, flexibility of the composite sheet 20 is not compromised.

In the examples shown in (b) of FIG. 4 and (b) of FIG. 5, although the nonwoven fabric 34 is limited to one that is “mainly formed of a fiber capable of maintaining shape at a temperature higher than the melting point of the resin film 11”; the “fiber capable of maintaining shape at a temperature higher than the melting point of the resin film 11” is not simply limited to a thermoplastic fiber having a higher melting point than the resin film 11, but is a concept also including, for example, regenerated cellulose fibers such as rayon and Lyocell and cotton linters.

Furthermore, as the method for manufacturing the nonwoven fabric 34, both a dry laid and a wet laid can be used.

Next, with reference to FIG. 6, a method for manufacturing the resin molded member 32 such as an automobile interior material by using the composite sheet 20 formed as described above will be described.

First, as shown in (a) of FIG. 6, the composite sheet 20 having the resin film 10 bonded through thermocompression on both sides is fixed on a first mold 26 (female mold) of an injection molding device 24. The composite sheet 20 may be pre-molded into a predetermined shape conforming to the inner surface of the first mold 26 by vacuum molding or the like.

Next, as shown in (b) of FIG. 6, the thermoplastic base resin material 30 that has been heated and melted is extruded into a cavity A from a nozzle of an injection unit which is not shown via a gate 28a formed on a second mold 28, and then the first mold 26 and the second mold 28 are closed. Here, as the base resin material 30, using at least one selected from the group consisting of polypropylene resins, ABS resins, AS resins, polycarbonate/ABS alloys, and polycarbonate is preferable.

After finishing forming the resin molded member 32 by cooling and hardening a surface protection/decoration portion formed of the composite sheet 20 and a main body portion formed of the base resin material 30, the formed resin molded member 32 is released from the cavity A as shown in (c) of FIG. 6.

In the method for manufacturing the resin molded member 32, the same or similar type of resin is preferably used for the functional layer 14 of the resin film 10 located on the surface on the side that makes contact with the base resin material 30 of the composite sheet 20 and the base resin material 30 to be adjoined with the functional layer 14. This is because, by doing so, the composite sheet 20 and the base resin material 30 can be firmly joined and integrated with high inter-layer strength.

In addition, when the surface of the first mold 26 is finished with a mirror surface, the mirror surface is transferred to the surface of the formed resin molded member 32, and whereby the time and effort of separately providing mirror surface processing with respect to the resin molded member 32 can be omitted.

### EXAMPLES

In the following, although the resin film of the present invention will be described by means of specific Examples and Comparative Examples, the present invention is not limited to those Examples.

Evaluation of the properties of each resin film (more specifically, melt-adhesion filling layer film) in the Examples and Comparative Examples was conducted by the following methods.

1. Property Evaluation of Resin Film

(1) Evaluation of Manufacturing Properties of Melt-Adhesion Filling Layer Film

(a) MFR of resin forming melt-adhesion filling layer: Measurements were conducted with a test condition of 170° C. under a load of 2.16 kg in conformance to JIS K 7210.

(b) T-die processability: A resin material mixture having a composition of the melt-adhesion filling layer was introduced, by using a single screw extruder having a screw diameter of 35 mm, in a 400-mm wide T-die designed to cause a uniform flow of melt resins within the die, and was extruded with a condition in which the resin temperature at a die outlet was 170° C. The lip gap was set to 1.0 mm. Then, a melt resin sheet extruded from the die was cooled to 30° C. by using a cooling roll to obtain an olefin based film having a layer thickness of 50 μm. T-die processability was visually observed and evaluated into four grades with double circle mark (EXCELLENT), circle mark (GOOD), triangle mark (ACCEPTABLE), and x-mark (UNACCEPTABLE).

(c) Inflation processability: When molding a monolayer film, the resin composition having the composition of the melt-adhesion filling layer was melted and kneaded by using a 35-mm extruder at an extrusion temperature of 200° C. with an amount of discharge of 5 kg/hr, extruded in a tubular form from a circular lip having a lip clearance of 0.5 mm and a peripheral length of 157 mm (diameter: 50 mm), and cooled with blowing air to create an inflation film having a thickness of 50 μm. Alternatively, when molding a multilayer film, the resin composition having the composition of the melt-adhesion filling layer is used as an internal layer, and a polypropylene resin (random polypropylene: WINTEC WFX4TA manufactured by Japan Polychem Corp.) was used as an intermediate layer and an outer layer to create a three-layer co-extrusion inflation film at a die temperature of 190° C. The bore diameter of the extruder was internal layer/intermediate layer/outer layer=200/200/200 (unit: mm in diameter), the layer composition ratio was internal layer/intermediate layer/outer layer=1/1/1 (total thickness=150 μm), and the laminated body molding speed was set to 8 m/min. The molding process for each inflation film was visually observed, and evaluated into four grades with double circle mark (EXCELLENT), circle mark (GOOD), triangle mark (ACCEPTABLE), and x-mark (UNACCEPTABLE).

(2) Evaluation of Physical Properties of Melt-Adhesion Filling Layer Film

(a) Impregnating ability: A 0.05-mm thick film of an Example or a Comparative Example to become melt-adhesion filling layers was set on both upper and lower surfaces of a machine-made Japanese paper (Unryu Japanese paper) having a thickness of 0.20 mm, and, on the outer side of each film, a 0.10-mm thick polypropylene film (functional layer) was overlaid and bonded through thermocompression at 180° C. with 1 MPa for 30 seconds by using a hot press. The obtained object was cooled to ordinary temperature while still being pressed to obtain a Japanese paper sheet (=composite sheet). A sample having a dimension of width 30 mm×length 100 mm was cut out from approximately the central portion of the obtained Japanese paper sheet, and an end surface thereof was photographed as an SEM picture enlarged by 200-fold. The degree of permeation of the melt-adhesion filling layer to the inside of the fabric material was visually observed, and evaluated into four grades with double circle mark (EXCELLENT), circle mark (GOOD), triangle mark (ACCEPTABLE), and x-mark (UNACCEPTABLE).

(b) Adhesiveness: A sample created with the same method for the evaluation of impregnating ability was used, and the polypropylene films on both outer and rear surfaces thereof were each set on a clamp of a tensile testing machine to pull the polypropylene films and measure the peeling strength between the Japanese paper sheet and the polypropylene film. The obtained results were evaluated into four grades with double circle mark (EXCELLENT), circle mark (GOOD), triangle mark (ACCEPTABLE), and x-mark (UNACCEPTABLE).

### Example 1

WINTEC (Registered trademark; product number WEG6NT) manufactured by Japan Polypropylene Corp., was prepared as a highly transparent polypropylene resin, and PP2101 manufactured by Nissen Chemitec Corp., was prepared as a high-MFR polypropylene resin for molecular weight adjustment. Then, 80 wt % of the highly transparent polypropylene resin and 20 wt % of the high-MFR polypropylene resin for molecular weight adjustment were mixed, and, with respect to 100 parts by weight of this resin mixture, 0.5 parts by weight of each of an ultraviolet ray absorbing agent ADEKA STAB (Registered trademark; product number 1413) manufactured by ADEKA Corp and an antioxidant IRGANOX (Registered trademark; product number 1010) manufactured by BASF (former Ciba Japan K.K.) was added. This mixture was extruded in a strand form at a temperature of 200° C. by using an extruder having a 35-mm diameter vent having mounted thereon an 80-mesh wire net. The strand was water-cooled, and cut to prepare a compound for the melt-adhesion filling layer. The obtained compound was dried at 90° C. for 8 hours, and one part thereof was used for evaluating the manufacturing properties of the melt-adhesion filling layer film as described above.

Subsequently, this compound was placed in an air-cooled inflation film forming machine with a 35-mm diameter set to a film formation temperature of 200° C. to mold a melt-adhesion filling layer film having a thickness of 50 μm.

The evaluation results of the physical properties of the obtained films and the evaluation results of film manufacturing properties with the described recipe are shown in Table 1.

### Example 2

WINTEC (Registered trademark; product number WFX4TA) manufactured by Japan Polypropylene Corp., was prepared as a highly transparent polypropylene resin, PP2101 manufactured by Nissen Chemitec Corp., was prepared as a high-MFR polypropylene resin for molecular weight adjustment, and YOUMEX (Registered trademark; product number 1010) manufactured by Sanyo Chemical Industries, Ltd., was prepared as a maleic acid modified polypropylene resin. Other than mixing 50 wt % of the highly transparent polypropylene resin, 40 wt % of the high-MFR polypropylene resin for molecular weight adjustment, and 10 wt % of the maleic acid modified polypropylene resin, a compound for the melt-adhesion filling layer was prepared similarly to Example 1, and the manufacturing properties of the melt-adhesion filling layer film and the physical properties of the obtained films were evaluated with methods similar to those in Example 1. The obtained results are shown in Table 1.

### Example 3

Other than that MODIC (Registered trademark; product number F534A) manufactured by Mitsubishi Chemical Corp., was prepared as a modified polyolefin based resin, PP2101 manufactured by Nissen Chemitec Corp., was prepared as a high-MFR polypropylene resin for molecular weight adjustment, and 80 wt % of the modified polyolefin based resin and 20 wt % of the high-MFR polypropylene resin for molecular weight adjustment were mixed; a compound for the melt-adhesion filling layer was prepared similarly to Example 1, and the manufacturing properties of the melt-adhesion filling layer film and the physical properties of the obtained films were evaluated with methods similar to those in Example 1. The obtained results are shown in Table 1.

### Example 4

Other than preparing a compound for the melt-adhesion filling layer by solely using, as a matrix resin, PP2101 manufactured by Nissen Chemitec Corp., which is a high-MFR polypropylene resin for molecular weight adjustment; the manufacturing properties of the melt-adhesion filling layer film and the physical properties of the obtained films were evaluated with methods similar to those in Example 1. The obtained results are shown in Table 1.

### Comparative Example 1

Other than preparing a compound for the melt-adhesion filling layer by solely using, as a matrix resin, WINTEC (Registered trademark; product number WEG6NT) manufactured by Japan Polypropylene Corp., which is a highly transparent polypropylene resin; the manufacturing properties of the melt-adhesion filling layer film and the physical properties of the obtained films were evaluated with methods similar to those in Example 1. The obtained results are shown in Table 1.

### Comparative Example 2

Other than that PP2101 manufactured by Nissen Chemitec Corp., was prepared as a high-MFR polypropylene resin for molecular weight adjustment, YOUMEX (Registered trademark; product number 1010) manufactured by Sanyo Chemical Industries, Ltd., was prepared as a maleic acid modified polypropylene resin, and 80 wt % of the high-MFR polypropylene resin for molecular weight adjustment and 20 wt % of the maleic acid modified polypropylene resin were mixed; a compound for the melt-adhesion filling layer was prepared similarly to Example 1, and the manufacturing properties of the melt-adhesion filling layer film and the physical properties of the obtained films were evaluated with methods similar to those in Example 1. The obtained results are shown in Table 1.

TABLE 1

| | MFR | T-die | Inflation | Impregnating | |
|---|---|---|---|---|---|
| Sample | (g/10 min.) | processability | processability | ability | Adhesiveness |
| Example 1 | 0.8 | Double circle | Double circle | Circle | Circle |
| Example 2 | 8.5 | Circle | Circle | Double circle | Double circle |
| Example 3 | 9.0 | Circle | Circle | Double circle | Circle |
| Example 4 | 40.0 | Triangle | Triangle | Double circle | Triangle |
| Comparative | 0.5 | Double circle | Circle | Triangle | X |
| Example 1 | | | | | |
| Comparative | 54.0 | Triangle | X | Double circle | Double circle |
| Example 2 | | | | | |

As shown in Table 1, the melt-adhesion filling layer films in the Examples are excellent in terms of manufacturability and the function as a melt-adhesion filling layer. On the other hand, in Comparative Example 1 in which the MFR of the resin forming the melt-adhesion filling layer is lower than the lower limit of the present invention, excellent film manufacturability was obtained but the obtained film did not function as the melt-adhesion filling layer at all. Conversely, when the MFR of the resin forming the melt-adhesion filling layer greatly exceeded the upper limit of the present invention, mainly the film manufacturability was deteriorated significantly.

2. Property Evaluations of Japanese Paper Sheet and Fabric Sheet

Next, as representatives of the composite sheet, a Japanese paper sheet using a Japanese paper as the fabric member, and a fabric sheet using a Jacquard textile as the fabric member were chosen to conduct the following property evaluations.

(1) Elongation Rate of Japanese Paper Sheet

Polypropylene films having a thickness of 0.05 mm were bonded through thermocompression on both outer and rear surfaces of a machine-made Japanese paper (Unryu Japanese paper) having a thickness of 0.075 mm via the melt-adhesion filling layer film of Example 1 to obtain a Japanese paper sheet having a thickness of 0.3 mm. Furthermore, a 0.2-mm nonwoven fabric was inserted between the rear surface of the Japanese paper and the melt-adhesion filling layer film, and a polypropylene film having a thickness of 0.05 mm was bonded thereon through thermocompression to create a nonwoven fabric-reinforced Japanese paper sheet having a thickness of 0.5 mm. By using this Japanese paper sheet and a machine-made Japanese paper (Unryu Japanese paper) having a thickness of 0.075 mm and not being laminated with the nonwoven fabric-reinforced Japanese paper sheet and the resin film, elongation rates were measured using the following method.

Specifically, three strands of test samples having a dimension of width 10 mm×length 200 mm were cut out from each sheet, and a tensile test was conducted by using Shimadzu Precision Universal Tester “Autograph” at a condition of room temperature: 15±5° C., humidity: 30±5%, speed: 1 mm/min, and gage length: 50 mm. Based on the obtained data, elongation rate (%) was calculated in accordance with formula (1) below.

Elongation rate (%)=(Maximum point displacement (mm) of composite sheet)/(maximum point displacement (mm) of fabric material)×100 (1)

As a result, as shown in Table 2 below, the Japanese paper stretched about 2.7-fold when the resin film formed of the melt-adhesion filling layer film and the polypropylene film was laminated, and showed an elongation rate of about 6.3-fold when reinforcement with the nonwoven fabric was conducted. The result of observing torn surfaces revealed that: in the case with the Japanese paper alone, entanglement of fibers was drawn, extended, and torn; in the case with the Japanese paper sheet, the laminated Japanese paper was torn and then the laminate film was drawn, extended, and torn; and in the case with the nonwoven fabric-reinforced Japanese paper sheet, the tearing did not occur independently for each material but the tearing occurred as an integrated sheet.

TABLE 2
Results of tensile test of composite sheet using
Japanese paper (n = 3; average values)

| | Maximum | | |
|---|---|---|---|
| | point stress | Maximum point | Elongation rate |
| Type of sheet | (N/mm²) | displacement (mm) | (%) |
| Japanese paper | 11.8 | 2.0 | 4.0 |
| Japanese paper sheet | 18.0 | 5.5 | 11.0 |
| Nonwoven | 29.5 | 12.8 | 25.6 |
| fabric-reinforced | | | |
| Japanese paper sheet | | | |

(2) Elongation Rate of Fabric (Jacquard Weave) Sheet

Polypropylene films having a thickness of 0.05 mm were bonded through thermocompression on both outer and rear surfaces of a fabric (Jacquard weave) having a thickness of 0.3 mm via the melt-adhesion filling layer film of the Example 1 to obtain a fabric sheet having a thickness of 0.5 mm. By using this fabric sheet and a fabric (Jacquard weave) having a thickness of 0.3 mm and not being laminated with the resin film, elongation rates were measured using the following method.

Specifically, three strands of test samples having a dimension of width 10 mm×length 200 mm were cut out from each sheet, and a tensile test was conducted by using Shimadzu Precision Universal Tester “Autograph” at a condition of room temperature: 15±5° C., humidity: 30±5%, speed: 1 mm/min, and gage length: 50 mm. Based on the obtained data, elongation rate (%) was calculated in accordance with the same formula (1) used for the Japanese paper sheet described above.

As a result, as shown in Table 3 below, the fabric showed an elongation rate of about 1.1-fold when the resin film formed of the melt-adhesion filling layer film and the polypropylene film was laminated. In addition, the result of observing the torn surfaces revealed that, in the case with the fabric alone, entanglement of fibers was drawn, extended, and torn, whereas, in the case with the fabric sheet, the tearing did not occur independently for each material but the tearing occurred as an integrated sheet.

TABLE 3
Results of tensile test of composite sheet
using fabric (n = 3; average values)

| | Maximum point | Maximum point | Elongation rate |
|---|---|---|---|
| Type of sheet | stress (N/mm²) | displacement (mm) | (%) |
| Fabric | 39.8 | 6.7 | 13.4 |
| Fabric sheet | 49.6 | 7.5 | 15.0 |

(3) Followability to Metal Mold when Using Japanese Paper Sheet and Fabric Sheet for Injection Molding

A nonwoven fabric-reinforced Japanese paper sheet and a fabric sheet similar to those used for the elongation rate measurement were prepared, and these composite sheets were set in test metal molds (several types with different curvature and depth of concave-convex parts were used) mounted on an injection molding machine NS-60-9A manufactured by Nissei Plastic Industrial Co., Ltd. Subsequently, an ABS resin (Techno ABS545 from Techno Polymer Co., Ltd.) was injection-molded on the rear surface side of the nonwoven fabric-reinforced Japanese paper sheet with a molding condition of injection pressure: at 60 MPa, first pressure with 50% and second pressure with 50%, injection speed: first speed with 10% and second speed with 10%, injection temperature: 260° C., and metal mold temperature: 50° C., to obtain a resin molded member sample for evaluating followability to a metal mold as shown in FIG. 7. The followability of the metal mold was evaluated by visually examining the presence of any tear of the composite sheet (particularly fabric material) at the flat surface of a projected part and a stepped part in each of the resin molded member samples.

The results showed that, since the elongation rate was high with the composite sheet laminated with the resin film as described above, followability of the metal mold was further improved significantly also in combination with preheating and the heating effect by the resin during molding, and that the composite sheet can handle shapes that require stretching and deep concavities and convexities, etc.

3. Manufacturing of Automobile Interior Member

By using the Japanese paper sheet and the fabric sheet used for the “Property evaluations of Japanese paper sheet and fabric sheet” described above, an automobile interior ornament which is a resin molded member was manufactured in the following manner.

First, a metal mold designed for insert molding was attached to an injection molding machine (Si-1801V manufactured by Toyo Machinery & Metals Co., Ltd.), and the metal mold was heated to a predetermined temperature.

Next, the Japanese paper sheet or the fabric sheet cut in accordance with the size of the molded article was attached to a positioning pin attached to a metal mold fixed side, and the metal mold was closed. Then, insert molding was conducted using a resin obtained by blending 80 parts by weight of a block polypropylene resin (AZ864 manufactured by Sumitomo Chemical Co., Ltd.) and 20 parts by weight of a master batch of talc (MF110 manufactured by Sumitomo Chemical Co., Ltd.) added as a filler. The resin injection condition during insert molding was injection speed: 30 mm/second, maximum injection pressure: 15 MPa, and cylinder temperature (actual measurement): around 180° C.

After the resin injected in the metal mold hardened, the metal mold was opened, the molded object was removed, and any composite sheet that had protruded from the outer circumference of the molded object was cut to finish manufacturing an automobile interior ornament. For the purpose of enhancing the external finishing, it is also possible to apply a primer, and then perform a clear finishing or a matte finishing giving complexity or a subdued finish.

The automobile interior ornament obtained as described above was able to satisfy all performances demanded for an automobile interior material, such as light resistance, heat resistance, moisture resistance, moist heat resistance, hardness, adhesiveness, impact resistance, chemical resistance, and appearance, etc.

### DESCRIPTION OF THE REFERENCE CHARACTERS

10 resin film
11 resin film (bonded through thermocompression on the rear surface side of the fabric material)
12 melt-adhesion filling layer
14 functional layer
16 intermediate layer
18 fabric material
20 composite sheet
22 heating roll
24 injection molding device
26 first mold (female mold)
28 second mold
30 base resin material
32 resin molded member
34 nonwoven fabric

1. (canceled)

2. A resin film to be attached to at least one surface of a fabric material formed of a natural fiber or a chemical/synthetic fiber, the resin film comprising:
a melt-adhesion filling layer formed of an olefin based resin that contains a modified polyolefin resin and has a melt flow rate (MFR: test condition being 170° C. under a load of 2.16 kg) higher than 0.5 g/10 min but lower than 54.0 g/10 min; and
a functional layer formed of a thermoplastic resin and laminated on a surface of the melt-adhesion filling layer, wherein
an intermediate layer formed of an olefin based polymer alloy or polymer blend is additionally interposed between the melt-adhesion filling layer and the functional layer.

3. A resin film to be attached to at least one surface of a fabric material formed of a natural fiber or a chemical/synthetic fiber, the resin film comprising:
a melt-adhesion filling layer formed of an olefin based resin that contains a modified polyolefin resin and has a melt flow rate (MFR: test condition being 170° C. under a load of 2.16 kg) higher than 0.5 g/10 min but lower than 54.0 g/10 min; and
a functional layer formed of a thermoplastic resin and laminated on a surface of the melt-adhesion filling layer, wherein
the thermoplastic resin forming the functional layer is at least one type selected from the group consisting of polymethyl methacrylate resins, polycarbonate resins, polypropylene resins, ABS resins, polyester based resins, polyethylene resins, polystyrene resins, and polyurethane resins.

4. The resin film according to claim 2, wherein
a colored material configured to absorb or diffuse electromagnetic waves having a wavelength of 380 to 500 nm is blended in at least one of the melt-adhesion filling layer or the intermediate layer.

5. A composite sheet having the resin film according to claim 2 bonded through thermocompression to, at a temperature not lower than a melting point of the melt-adhesion filling layer, at least an outer surface side of the fabric material formed of a natural fiber or a chemical/synthetic fiber.

6. The composite sheet according to claim 5, wherein
a nonwoven fabric mainly formed of a fiber capable of maintaining shape at a temperature higher than a melting point of a resin film is interposed between a rear surface of the fabric material formed of a natural fiber or a chemical/synthetic fiber and the resin film to be bonded through thermocompression to a side of the rear surface.

7. The composite sheet according to claim 5, wherein
a nonwoven fabric mainly formed of a fiber capable of maintaining shape at a temperature higher than a melting point of a resin film is laminated on an outer surface side of the resin film bonded through thermocompression to a rear surface of the fabric material formed of a natural fiber or a chemical/synthetic fiber.

8. A resin molded member molded into a predetermined shape by using the composite sheet according to claim 5 and having a thermoplastic base resin material injection-molded on, and integrally formed with, a rear surface of the composite sheet.
